(19) United States
(12) Patent Application Publication
(10) Pub. No.: US 2024/0263656 A1
(43) Pub. Date: Aug. 8, 2024

(54) FIXING STRUCTURE

(71) Applicant: YAZAKI CORPORATION, Tokyo (JP)

(72) Inventors: Yoshimichi Yamao, Toyota-shi (JP); Satoshi Yokoyama, Toyota-shi (JP); Masayoshi Ogawa, Toyota-shi (JP)

(21) Appl. No.: 18/639,947

(22) Filed: Apr. 18, 2024

Related U.S. Application Data
(63) Continuation of application No. PCT/JP2023/000670, filed on Jan. 12, 2023.

(30) Foreign Application Priority Data
Feb. 16, 2022 (JP) 2022-021854

(51) Int. Cl. F16B 2/10; F16L 3/13

(52) U.S. Cl. CPC F16B 2/10; F16L 3/13

(57) ABSTRACT

A fixing structure includes: a main body through which a stud bolt is inserted from one side toward the other side in an axial direction; a pair of first locking pieces locked to a bolt groove of the stud bolt inserted through the main body; a pair of second locking pieces locked to the bolt groove of the stud bolt inserted through the main body; and a pair of deflection amount regulators contactable with the first locking pieces. The first locking pieces each includes an elastically deformable blade and a claw locked to the bolt groove, and the deflection amount regulators each comes into contact with the blade to regulate the deflection amount of the blade.

### CROSS-REFERENCE TO RELATED APPLICATION

This application is a continuation application of International Application No. PCT/JP2023/000670 filed on Jan. 12, 2023 which claims the benefit of priority from Japanese Patent Application No. 2022-021854 filed on Feb. 16, 2022 and designating the U.S., the entire contents of which are incorporated herein by reference.

### BACKGROUND OF THE INVENTION

### 1. Field of the Invention

The present invention relates to a fixing structure.

### 2. Description of the Related Art

As a technique for mounting a mounting member such as a wire harness, a pipe, or a heat insulating member to a mounted member such as a vehicle body of an automobile, for example, Japanese Patent Application Laid-open No. H11-173320 A discloses a locking tool including: a base including a stud receiving hole for receiving a stud formed with a screw or a peripheral groove, and a stud locking part for locking itself to the screw or the like of the stud. The locking tool includes a protrusion that restricts movement of the stud locking part toward a stud root side when force to tear off the mounting member and the mounted member is applied.

As a holder that holds a stud by being locked to a screw or a peripheral groove of the stud, Japanese Patent Application Laid-open No. 2009-185902 A discloses a holder including a pair of side walls forming a stud receiving space for receiving the stud and a stud locking piece that is constituted by a deflection piece having a specific shape.

As a fixture for fixing a stud bolt by engaging therewith, Japanese Patent Application Laid-open No. H09-32833 A discloses a fixture including a locking piece that engages with the stud bolt and a spring piece that biases the locking piece so as to engage a claw of the locking piece with the stud bolt.

In the locking tool as described above, when the locking tool is attached to the stud bolt, for example, the stud bolt may obliquely enter, and normal locking may not be performed.

### SUMMARY OF THE INVENTION

The present invention has been made in view of the above circumstances, and an object of the present invention is to provide a fixing structure that can appropriately mount a mounting member on a mounted member upon mounting the mounting member on the mounted member including the stud bolt by preventing oblique entry of the stud bolt.

In order to achieve the above mentioned object, a fixing structure according to one aspect of the present invention includes a main body that is provided in a mounting member and through which a stud bolt fixed to a mounted member is inserted from one side to the other side in an axial direction; a pair of first locking pieces being provided to face each other at the main body in a width direction intersecting the axial direction, the pair of first locking pieces being locked to a bolt groove of the stud bolt inserted through the main body; a pair of second locking pieces being provided to face each other at the main body in the width direction, the pair of second locking pieces being located on the other side in the axial direction with respect to the pair of first locking pieces, and the pair of second locking pieces being locked to the bolt groove of the stud bolt inserted through the main body; and a pair of deflection amount regulators being provided to face each other at the main body in the width direction, the pair of deflection amount regulators being contactable with the pair of first locking pieces, respectively, wherein the main body includes: a pair of end face walls being located to face each other in the axial direction, each of the pair of end face walls including a bolt insertion hole through which the stud bolt is to be inserted; a pair of side face walls being located to face each other in the width direction, each of the pair of side face walls extending between the pair of end face walls in the axial direction; and a bolt receiving space being formed by being surrounded by the pair of end face walls and the pair of side face walls, the bolt receiving space being configured to receive the stud bolt inserted through the bolt insertion hole, each of the pair of first locking pieces includes: a blade being formed by protruding from a corresponding one of the pair of side face walls toward the bolt receiving space and extending toward the other side in the axial direction, the blade being elastically deformable; and a claw being formed by protruding from the blade, the claw being locked to the bolt groove, each of the pair of second locking pieces include: a blade being formed by protruding from a corresponding one of the pair of side face walls toward the bolt receiving space and extending toward the other side in the axial direction, the blade being elastically deformable; and a claw being formed by protruding from the blade and being locked to the bolt groove, the blade of each of the pair of second locking pieces is fixed such that an end of the blade on the other side in the axial direction is adjacent to the bolt insertion hole of an end face wall located on the other side in the axial direction among the pair of end face walls, and each of the pair of deflection amount regulators is formed by protruding from a corresponding one of the pair of side face walls toward the bolt receiving space, and each of the pair of deflection amount regulators comes into contact with the blade to regulate a deflection amount of the blade.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a schematic configuration of a fixing structure according to an embodiment;

FIG. 2 is a perspective view illustrating a schematic configuration of the fixing structure (when a stud bolt is inserted) according to the embodiment;

FIG. 3 is a side view illustrating a schematic configuration of the fixing structure according to the embodiment;

FIG. 4 is a side view illustrating a schematic configuration of the fixing structure (when the stud bolt is inserted) according to the embodiment; and

FIG. 5 is a sectional view of the fixing structure according to the embodiment.

### DETAILED DESCRIPTION OF THE PREFERRED EMBODIMENTS

Hereinafter, an embodiment according to the present invention will be described in detail with reference to the drawings. Note that this invention is not limited to the embodiment. Constituent elements in the following embodiment include those that can be easily replaced by a person skilled in the art or those that are substantially the same.

In the following description, among a first direction, a second direction, and a third direction intersecting one another, the first direction is referred to as an “axial direction X”, the second direction is referred to as a “width direction Y”, and the third direction is referred to as a “depth direction Z”. Here, the axial direction X, the width direction Y, and the depth direction Z are orthogonal to one another. The axial direction X typically corresponds to a direction in which the stud bolt is inserted through the main body of the fixing structure and corresponds to a direction in which the pair of end face walls face each other. The width direction Y typically corresponds to a direction in which the pair of side face walls face each other and corresponds to a direction in which the pair of locking pieces correspond to each other. Each direction used in the following description will be described as a direction in a state in which the parts are assembled to one another unless otherwise specified.

### Embodiment

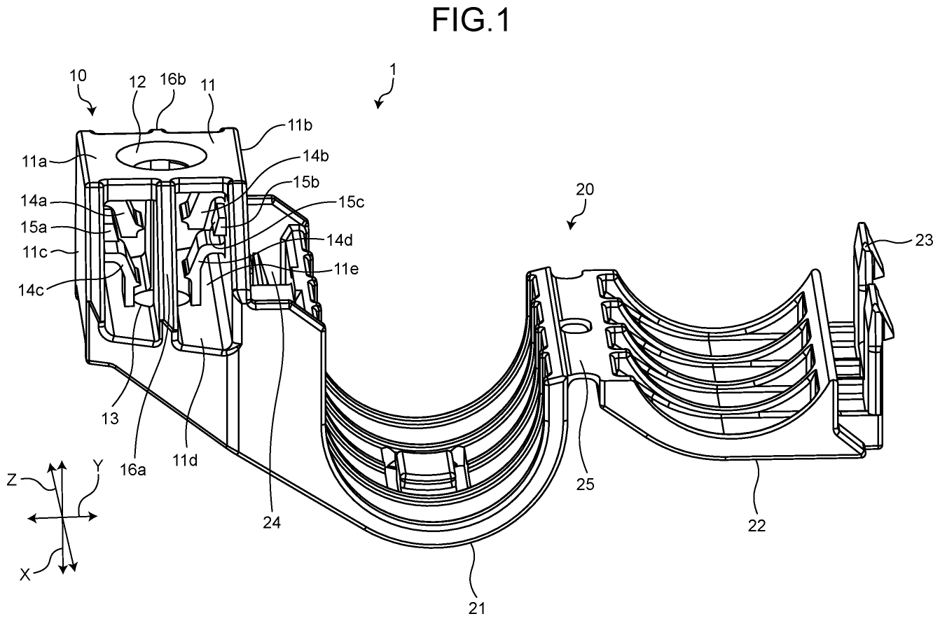

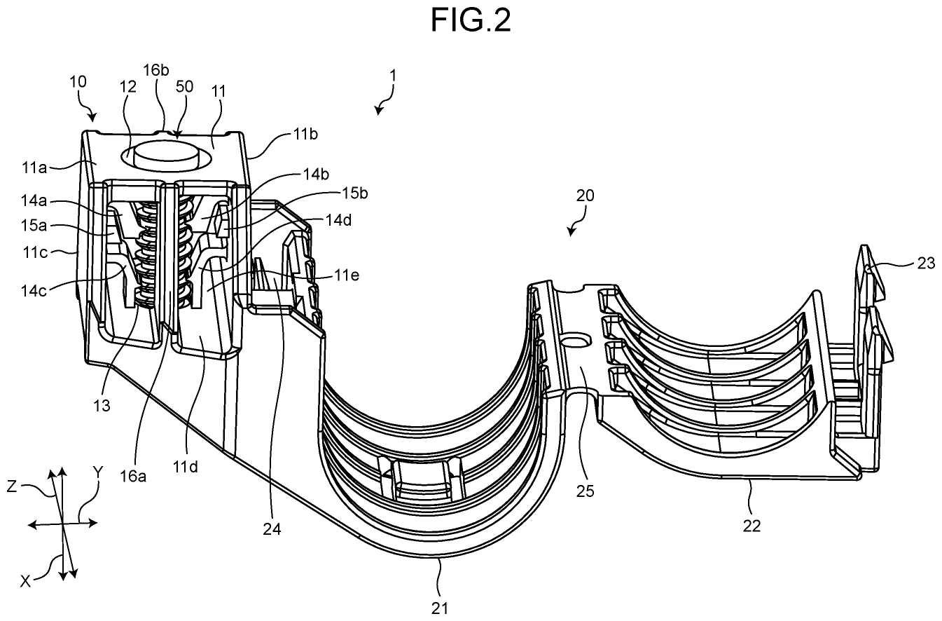

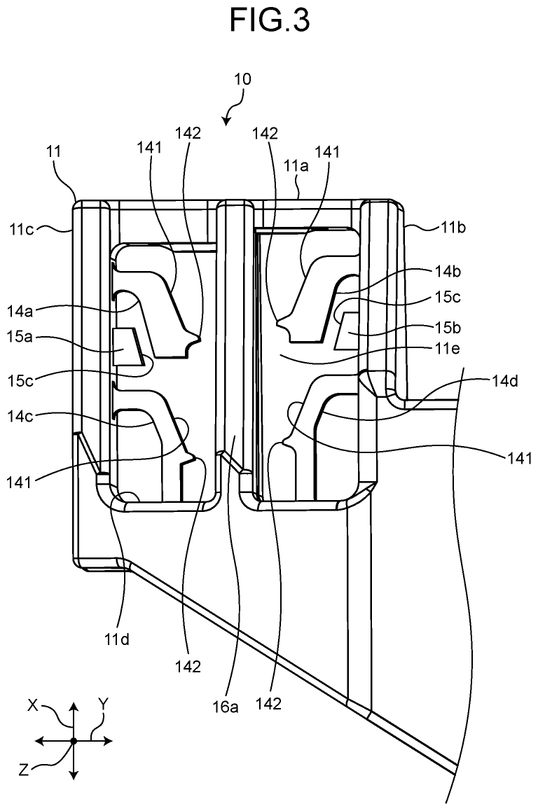

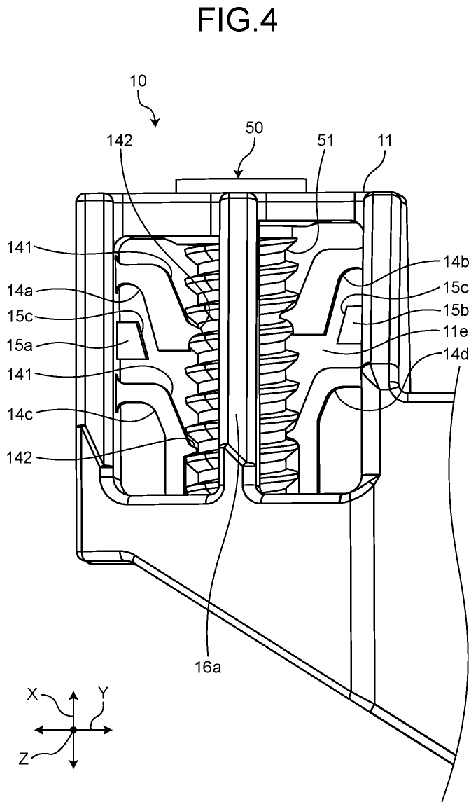

One embodiment of a fixing structure according to the present invention will be described with reference to FIGS. 1 to 5. In FIGS. 2 and 4, illustration of the mounted member is omitted, and only the stud bolt is illustrated.

As illustrated in FIGS. 1 and 2, a fixing structure 10 according to the present embodiment is provided in a mounting member 1 and locks a stud bolt 50 fixed to a mounted member (not illustrated). The stud bolt 50 includes a bolt groove 51 having a spiral shape or an annular shape formed in a shaft. The mounting member 1 is used, for example, to fix a cable or the like to a mounted member such as a vehicle body panel. In the mounting member 1, a holding member 20 that holds the cable and the like and the fixing structure 10 are integrally formed using a resin material having an insulating property. The holding member 20 constitutes a protector that is externally mounted on a cable or the like, protects the cable or the like, and regulates a routing path of the cable or the like. The holding member 20 includes a first holder part 21 and a second holder part 22, both of which have a semi-cylindrical shape. The first holder part 21 and the second holder part 22 are continuously connected by a connection part 25. The second holder part 22 is bent at the connection part 25 to form a cylindrical holder together with the first holder part 21. By inserting and locking an engaging part 23 into an insertion opening 24, the holding member 20 is fixed in a state in which the first holder part 21 and the second holder part 22 form the holder. Note that the configuration of the holding member 20 is merely an example, and a holding member having another configuration may be adopted.

The fixing structure 10 includes: a main body 11 through which the stud bolt 50 fixed to the mounted member is inserted from one side to the other side in the axial direction X; a pair of upper locking pieces 14a and 14b that is provided to face each other at the main body 11 in the width direction Y intersecting the axial direction X and is locked to the bolt groove 51 of the stud bolt 50 inserted through the main body 11; a pair of lower locking pieces 14c and 14d that are located on the other side in the axial direction X with respect to the upper locking pieces 14a and 14b, respectively; and a pair of deflection amount regulators 15a and 15b that is provided to face each other at the main body 11 in the width direction Y and is contactable with the upper locking pieces 14a and 14b, respectively. In the fixing structure 10 of the present embodiment, the pair of upper locking pieces 14a and 14b corresponds to a pair of first locking pieces, and the pair of lower locking pieces 14c and 14d corresponds to a pair of second locking pieces. In the fixing structure 10, the stud bolt 50 is inserted from one side, that is, from a bolt insertion hole 12, and inserted toward the other side, that is, toward a bolt insertion hole 13, and the distal end of the stud bolt 50 passes through bolt insertion hole 13 to protrude therefrom.

The main body 11 includes: a pair of end face walls 11a and 11d located to face each other in the axial direction X and respectively formed with bolt insertion holes 12 and 13 through which the stud bolt 50 is inserted; a pair of side face walls 11b and 11c located to face each other in the width direction Y and each extending between the pair of end face walls 11a and 11d in the axial direction X; and a pair of supports 16a and 16b located to face each other in the depth direction Z and each extending between the pair of end face walls 11a and 11d in the axial direction X. A space formed by being surrounded by the pair of end face walls 11a and 11d and the pair of side face walls 11b and 11c constitutes a bolt receiving space 11e that receives the stud bolt 50 inserted through the bolt insertion hole 12.

A bolt insertion hole 12 through which the stud bolt 50 is inserted is formed at the end face wall 11a, and the bolt insertion hole 13 is formed at the end face wall 11d. The end face wall 11d and the end face wall 11a are disposed to face each other in the axial direction X, that is, the stud bolt 50 insertion direction.

The side face wall 11b is provided to extend between the end face walls 11a and 11d. On a wall face of the side face wall 11b on the bolt receiving space 11e side, the upper locking piece 14b, the deflection amount regulator 15b, and the lower locking piece 14d are disposed in this order from the end face wall 11a side to the end face wall 11d side.

The side face wall 11c is provided to extend between the end face walls 11a and 11d. On a wall face of the side face wall 11c on the bolt receiving space 11e side, the upper locking piece 14a, the deflection amount regulator 15a, and the lower locking piece 14c are disposed in this order from the end face wall 11a side to the end face wall 11d side.

The supports 16a and 16b are each provided to extend between the end face walls 11a and 11d. The supports 16a and 16b are formed such that the width from one side (the bolt insertion hole 12 side) to the other side (the bolt insertion hole 13 side) in the axial direction X gradually increases. The supports 16a and 16b connect the bolt insertion hole 12 and the bolt insertion hole 13. As a result, the fixing structure 10 prevents oblique entry of the stud bolt 50 in the directions toward the supports 16a and 16b.

The upper locking pieces 14a and 14b are formed to protrude from the side face walls 11c and 11b, respectively, toward the bolt receiving space 11e side and each extend toward the other side in the axial direction X. The upper locking pieces 14a and 14b each include an elastically deformable blade 141 and a claw 142 formed to protrude from the blade 141 and locked to the bolt groove 51. The upper locking pieces 14a and 14b are each formed to have a width in the depth direction Z slightly larger than the diameter of the stud bolt 50. For example, the width is about 5 mm.

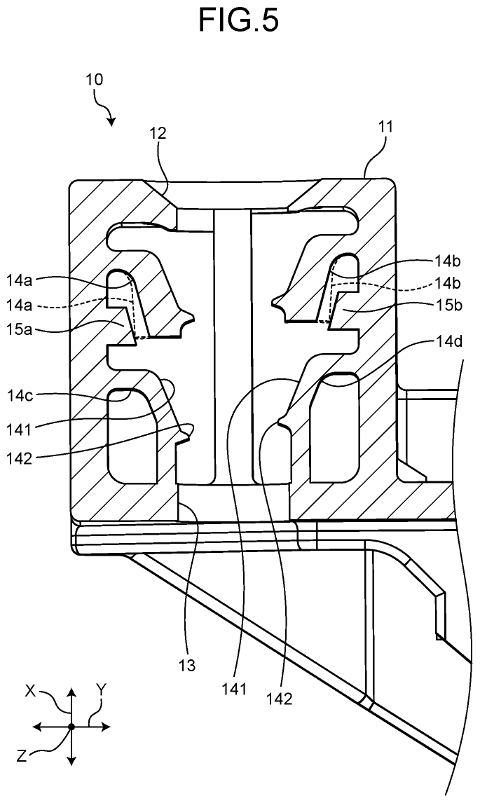

The deflection amount regulators 15a and 15b are provided at positions where distal ends of the blades 141 on the other side in the axial direction X come into contact with the side face walls 11c and 11b, respectively, when the blades 141 of the upper locking pieces 14a and 14b are respectively deflected toward the side face walls 11cand 11b with the insertion of the stud bolt 50 into the bolt insertion hole 12 (see dotted lines in FIG. 5).

The upper locking pieces 14a and 14b are deflected upon the insertion of the stud bolt 50 to reduce force (insertion force) required to insert the stud bolt 50. The reduced thickness of the upper locking pieces 14a and 14b can reduce the insertion force of the stud bolt 50. However, when the stud bolt 50 is inserted while deviating from the axial direction X, the insertion direction of the stud bolt 50 may not be able to be returned to the axial direction X by the elastic force of the upper locking pieces 14a and 14b. Thus, the distal end of the stud bolt 50 may not be able to pass through the bolt insertion hole 13. On the other hand, in the present embodiment, the deflection amount regulators 15a and 15b are provided at positions where the distal ends of the blades 141 of the upper locking pieces 14a and 14b would respectively come into contact with. With this configuration, the deflection amounts of the upper locking pieces 14a and 14b can be regulated (see dotted lines in FIG. 5). In this way, even when the stud bolt 50 is inserted while deviating from the axial direction X, the insertion direction of the stud bolt 50 can be regulated to the direction in which the distal end of the stud bolt 50 can pass through the bolt insertion hole 13 while reducing the insertion force of the stud bolt 50 by reducing the elastic force of the upper locking pieces 14a and 14b. As a result, upon mounting the mounting member 1 on the mounted member including the stud bolt 50, the fixing structure 10 can appropriately mount the mounting member 1 on the mounted member by preventing oblique entry of the stud bolt 50.

Contact faces 15c of the deflection amount regulators 15a and 15b with the respective upper locking pieces 14a and 14b are formed so as to be substantially parallel to the extending direction of the blades 141 of the respective upper locking pieces 14a and 14b. Each of the deflection amount regulators 15a and 15b can increase the contact area between the blade 141 and the contact face 15c upon the deflection of the blade 141 due to the insertion of the stud bolt 50 by making the contact face 15c substantially parallel to the extending direction of the blade 141. With this configuration, each of the deflection amount regulators 15a and 15b can reduce the stress applied per unit contact area of the blade 141 and can prevent the blade 141 from being broken.

The lower locking pieces 14c and 14d are formed to protrude from the side face walls 11c and 11b, respectively, toward the bolt receiving space 11e side and each extend toward the other side in the axial direction X. The lower locking pieces 14c and 14d each include an elastically deformable blade 141 and the claw 142 formed to protrude from the blade 141 and locked to the bolt groove 51. The blades 141 of the lower locking pieces 14c and 14d are fixed such that the ends of the blades 141 on the other side in the axial direction X are adjacent to the bolt insertion hole 13 of the end face wall 11d located on the other side in the axial direction X. The lower locking pieces 14c and 14d are each formed to have a width in the depth direction Z slightly larger than the diameter of the stud bolt 50, similarly to the upper locking pieces 14a and 14b. For example, the width is about 5 mm.

The lower locking pieces 14c and 14d reduce the insertion force of the stud bolt 50 due to deflection upon the insertion of the stud bolt 50, similarly to the upper locking pieces 14a and 14b. The thicknesses of the lower locking pieces 14c and 14d are adjusted in order to adjust the insertion force of the stud bolt 50. In order to prevent oblique entry of the stud bolt 50, the blades 141 of the lower locking pieces 14c and 14d are fixed such that the ends of the blades 141 on the other side in the axial direction X are adjacent to the bolt insertion hole 13 of the end face wall 11d located on the other side in the axial direction X. The lower locking pieces 14c and 14d can guide the insertion of the distal end of the stud bolt 50 into the bolt insertion hole 13 while reducing the insertion force of the stud bolt 50 by fixing the ends of the blades 141 of the lower locking pieces 14c and 14d adjacently to the bolt insertion hole 13. Note that, from the viewpoint of the insertability of the stud bolt 50 into the bolt insertion hole 13, the blades 141 of the lower locking pieces 14c and 14d are preferably fixed to the bolt insertion hole 13 without a step (to be flush).

Note that, in the present embodiment, the stud bolt 50 is locked by the upper locking pieces 14a and 14b and the lower locking pieces 14c and 14d, but it is not necessary to provide the lower locking pieces 14c and 14d in the fixing structure 10 in applications in which high fixing strength of the mounting member 1 to the mounted member is not required. The fixing structure 10 may be provided with additional locking pieces. For example, a pair of third locking pieces may be provided between the upper locking pieces 14a and 14b and the lower locking pieces 14c and 14d.

In the present embodiment, the ends of the blades 141 of the lower locking pieces 14c and 14d are fixed adjacently to the bolt insertion hole 13, but are not necessarily fixed. By regulating the deflection amounts of the upper locking pieces 14a and 14b located on one side in the axial direction X by the respective deflection amount regulators 15a and 15b, the insertion direction of the stud bolt 50 can be effectively regulated in a direction in which the stud bolt 50 can pass through the bolt insertion hole 13 even upon oblique entry of the stud bolt 50.

The insertion direction of the stud bolt 50 can be effectively regulated even with a configuration in which the ends of the blades 141 of the lower locking pieces 14c and 14d are not fixed adjacently to the bolt insertion hole 13 and a pair of deflection amount regulators contactable with the blades 141 of the lower locking pieces 14c and 14d are provided. When two or more pairs of locking pieces are provided and only one pair of deflection amount regulators are provided, the deflection amount regulators are preferably provided at positions where the deflection amount regulators are contactable with the respective locking pieces closest to one side in the axial direction.

The fixing structure according to the present embodiment has an effect that, upon mounting the mounting member on the mounted member including the stud bolt, a mounting member can be appropriately mounted on a mounted member by preventing oblique entry of the stud bolt.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

1. A fixing structure comprising:
a main body that is provided in a mounting member and through which a stud bolt fixed to a mounted member is inserted from one side to the other side in an axial direction;
a pair of first locking pieces being provided to face each other at the main body in a width direction intersecting the axial direction, the pair of first locking pieces being locked to a bolt groove of the stud bolt inserted through the main body;
a pair of second locking pieces being provided to face each other at the main body in the width direction, the pair of second locking pieces being located on the other side in the axial direction with respect to the pair of first locking pieces, and the pair of second locking pieces being locked to the bolt groove of the stud bolt inserted through the main body; and
a pair of deflection amount regulators being provided to face each other at the main body in the width direction, the pair of deflection amount regulators being contactable with the pair of first locking pieces, respectively, wherein
the main body includes:
a pair of end face walls being located to face each other in the axial direction, each of the pair of end face walls including a bolt insertion hole through which the stud bolt is to be inserted;
a pair of side face walls being located to face each other in the width direction, each of the pair of side face walls extending between the pair of end face walls in the axial direction; and
a bolt receiving space being formed by being surrounded by the pair of end face walls and the pair of side face walls, the bolt receiving space being configured to receive the stud bolt inserted through the bolt insertion hole,
each of the pair of first locking pieces includes:
a blade being formed by protruding from a corresponding one of the pair of side face walls toward the bolt receiving space and extending toward the other side in the axial direction, the blade being elastically deformable; and
a claw being formed by protruding from the blade, the claw being locked to the bolt groove,
each of the pair of second locking pieces include:
a blade being formed by protruding from a corresponding one of the pair of side face walls toward the bolt receiving space and extending toward the other side in the axial direction, the blade being elastically deformable; and
a claw being formed by protruding from the blade and being locked to the bolt groove,
the blade of each of the pair of second locking pieces is fixed such that an end of the blade on the other side in the axial direction is adjacent to the bolt insertion hole of an end face wall located on the other side in the axial direction among the pair of end face walls, and
each of the pair of deflection amount regulators is formed by protruding from a corresponding one of the pair of side face walls toward the bolt receiving space, and each of the pair of deflection amount regulators comes into contact with the blade to regulate a deflection amount of the blade.

2. The fixing structure according to claim 1, wherein
each of the pair of deflection amount regulators is provided at a position where a distal end of the blade on the other side in the axial direction comes into contact with a corresponding one of the pair of side face walls, when the blade is deflected with insertion of the stud bolt.
